(19) United States
(12) Patent Application Publication
(10) Pub. No.: US 2008/0037999 A1
(43) Pub. Date: Feb. 14, 2008

(54) Wideband modulated signal generating device

(76) Inventors: Kouichi Masuda, Osaka (JP); Tomoaki Ohira, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/882,252

(22) Filed: Jul. 31, 2007

(30) Foreign Application Priority Data
Aug. 1, 2006 (JP) 2006-209654

(51) Int. Cl. H04B 10/04; H04B 10/12

(52) U.S. Cl. 398/186

(57) ABSTRACT

The present invention provides a wideband modulated signal generating device capable of realizing an always stable operation and obtaining an intended wideband modulated signal in spite of a shift in the optimal bias voltage due to DC drift occurring in an optical intensity modulation section. In the wideband modulated signal generating device, a DC power supply control section 50 controls a first DC power supply 51 and a second DC power supply 52 for applying first and second bias voltages to an optical intensity modulation section 30 based on a signal level detected by a level detecting section 70, and controls a third DC power supply 53 for applying a third bias voltage to an optical intensity modulation section 30 based on a distortion level detected by a distortion level detecting section 81, thus compensating for a shift in the optimal bias voltage occurring due to DC drift.

### BACKGROUND OF THE INVENTION

1. Field of the Invention

The present invention relates to a wideband modulated signal generating device for generating a wideband modulated signal (a phase-modulated signal or a frequency-modulated signal), and more particularly to a wideband modulated signal generating device using an external optical modulator capable of a bias voltage control of making the bias voltage applied to the external optical modulator follow the fluctuations of the optimal bias voltage due to DC drift.

2. Description of the Background Art

Examples of conventional wideband modulated signal generating methods using the wideband property of light include a method for generating a wideband modulated signal through a heterodyne detection using the chirp characteristics of semiconductor lasers (e.g., Non-Patent Document 1).

Non-Patent Document 1: K. Kikushima, et al., “Optical Super Wide-Band FM Modulation Scheme and Its Application to Multi-Channel AM Video Transmission Systems”, IOOC '95 Technical Digest, Vol. 5 PD2-7, pp. 33-34

FIG. 10 is a block diagram showing a configuration of a conventional wideband modulated signal generating device. The operation, etc., of the wideband modulated signal generating device are discussed in detail in Non-Patent Document 1. Referring to FIG. 10, the wideband modulated signal generating device includes an optical frequency control section 900, a signal source 901, a local light source 902, an optical modulation section 903, a light combining section 904, and a light detecting section 905.

With the wideband modulated signal generating device having such a configuration, the signal source 901 outputs an electric signal being the original signal to be subjected to an angular modulation. The optical modulation section 903 may be a semiconductor laser. Typically, where the injected current is constant, a semiconductor laser oscillates to output light having a constant optical frequency f₁. When the current injected into the semiconductor laser is amplitude-modulated, the frequency of the output light is also modulated, thus outputting an optical frequency-modulated signal centered about an optical frequency f₁. With such a nature, the optical modulation section 903 converts the electric signal outputted from the signal source 901 to an optical frequency-modulated signal. The local light source 902 outputs an unmodulated optical signal having a constant optical frequency f₂.

The optical frequency-modulated signal outputted from the optical modulation section 903 and the optical signal outputted from the local light source 902 are combined together by the light combining section 904 and inputted to the light detecting section 905. The light detecting section 905 may be a photodiode having squared detection characteristics, or the like. The light detecting section 905 outputs a beat signal between two input optical signals at a frequency f_{C} (=|f₁−f₂|) corresponding to the difference between the optical frequencies of the two optical signals. This is called an optical heterodyne detection.

The beat signal thus obtained is an angle-modulated signal (frequency-modulated signal) having a carrier frequency f_{C} with the original signal being the electric signal outputted from the signal source 901. The optical frequency control section 900 controls one or both of the center optical frequency f₁ of the optical signal outputted from the optical modulation section 903 and the optical frequency f₂ of the optical signal outputted from the local light source 902 so as to stabilize the center frequency f_{C} of the angle-modulated signal outputted from the light detecting section 905.

As described above, the wideband modulated signal generating device uses a high modulation efficiency of optical signal processing (a high efficiency that is 10 times or more higher than that obtained with a general electric circuit), whereby it is possible to easily produce an angle-modulated signal having a very high frequency and being wideband (with a large frequency or phase deviation), which is difficult to produce with a general electric circuit. However, a light source such as a semiconductor laser typically has greater phase noise (a greater oscillation spectral line width) as compared with an electric oscillator.

Referring to FIGS. 11A to 11C, phase noise contained in signals outputted from the various components of the conventional wideband modulated signal generating device will be discussed. FIG. 11A is a schematic diagram showing a frequency spectrum of an optical signal outputted from the local light source 902. FIG. 11B is a schematic diagram showing a frequency spectrum of an optical signal outputted from the optical modulation section 903. FIG. 11C is a schematic diagram showing a frequency spectrum of a signal outputted from the light detecting section 905.

In FIG. 11A, the phase noise (the oscillation spectral line width) of the local light source 902 is denoted as Δν1. In FIG. 11B, the phase noise (the oscillation spectral line width) contained in the optical signal outputted from the optical modulation section 903 is denoted as Δν2. The angle-modulated signal obtained as the beat signal between these optical signals has phase noise (Δν1+Δν2) corresponding to the sum of two phase noise, as shown in FIG. 11C. This is because there is no phase level correlation between light waves outputted from the light sources, and thus the phase noise are simply added together. When an angle-modulated signal is demodulated, the phase noise is also demodulated to become substantial white (intensity) noise. Thus, the conventional wideband modulated signal generating device has the characteristic problem that the quality of the demodulated signal deteriorates significantly due to the noise.

The conventional wideband modulated signal generating device shown in FIG. 10 needs to successively monitor the optical frequencies of the two light sources (or the difference therebetween) in order to stabilize the frequency of the angle-modulated signal. Thus, the conventional device has the characteristic problem that it requires a complicated component such as a control circuit for monitoring/adjustment (e.g., the optical frequency control section 900).

In order to solve the problem, a conventional wideband modulated signal generating device disclosed in Japanese Laid-Open Patent Publication No. 2001-133824 (hereinafter referred to as “Patent Document 1”) employs a configuration as shown in FIG. 12. Referring to FIG. 12, the conventional wideband modulated signal generating device splits the light outputted from a light source 2000 into two, one of which is subjected to a predetermined optical intensity modulation through an optical intensity modulation section 2003 with the original signal being a first electric signal having a predetermined frequency f_{C} outputted from a first signal source 2007 to thereby produce an optical intensity-modulated signal. The other light is subjected to an optical angular modulation through an optical angle modulation section 2004 with the original signal being a second electric signal outputted from a second signal source 2008 to thereby produce an optical angle-modulated signal. A light combining section 2005 combines together the optical intensity-modulated signal produced by the optical intensity modulation section 2003 and the optical angle-modulated signal produced by the optical angle modulation section 2004.

A light detecting section 2006 homodyne-detects the optical intensity-modulated signal and the optical angle-modulated signal, which have been combined together by the light combining section 2005, and produces, as the difference beat signal therebetween, an angle-modulated signal centered about the frequency f_{C} with the original signal being the output signal from the second signal source 2008. The optical angle-modulated signal and the optical intensity-modulated signal each have the same phase noise Δν as that of the light source 2000, and these phase noise are canceled out by each other in the angle-modulated signal being the difference beat component. Specifically, even if the optical frequency of the optical angle-modulated signal fluctuates up and down due to the influence of the phase noise, the optical frequency of the optical intensity-modulated signal undergoes the same fluctuations, whereby the frequency difference between these signals is always constant irrespective of the frequency fluctuations. Therefore, with the conventional wideband modulated signal generating device shown in FIG. 12, it is possible to obtain an angle-modulated signal with desirable noise characteristics.

However, for the optical intensity modulation section 2003 of the conventional wideband modulated signal generating device shown in FIG. 12, it is necessary to provide an optical SSB modulator capable of performing a double-sideband suppressed-optical carrier modulation or a single-sideband suppressed-optical carrier modulation. For example, for an optical SSB modulator capable of performing a single-sideband suppressed-optical carrier modulation, there are very limited bias conditions under which carrier light or unnecessary sideband light components are canceled out by each other, whereby unnecessary light components are produced even by slight changes in the bias voltage. With an optical SSB modulator using lithium niobate, there is a phenomenon called “DC drift” where the point of operation shifts over time. Thus, even when the bias voltage does not change, the optimal point of operation may shift over time, thus producing unnecessary light components. Therefore, the optical signal outputted from the optical intensity modulation section 2003 may include unnecessary light components as shown in FIG. 13A.

FIG. 13C shows the spectrum of an electric signal obtained when the optical signal outputted from the optical intensity modulation section 2003 (see FIG. 13A) and the optical signal outputted from the optical angle modulation section 2004 (see FIG. 13B) are combined together and homodyne-detected by the light detecting section 2006, where there are unnecessary light components. As shown in FIG. 13C, the electric signal homodyne-detected by the light detecting section 2006 includes an unnecessary component having the same center frequency as that of the intended angle-modulated signal, an unnecessary component whose center frequency is DC. When an angle-modulated signal including such unnecessary wave components is demodulated, the distortion characteristics may be deteriorated (see, for example, Non-Patent Document 2).

Non-Patent Document 2: Ohira, et al., “Study Of Wideband Fm Modulation Scheme Using Optical Homodyne Detection—System Proposal And Basic Characteristics Of Wideband Modulator—”, IEICE Technical Report

The distortion characteristics are shown in FIGS. 14A and 14B. FIG. 14A shows the distortion characteristics with respect to the level difference between the J₊₁ component being the upper sideband and the optical carrier J₀ component. FIG. 14B shows the distortion characteristics with respect to the level difference between the J₊₁ component being the upper sideband and the J₋₁ component being the lower sideband. As can be seen from FIGS. 14A and 14B, both of the unnecessary wave components substantially influence the distortion characteristics. Thus, it can be seen that it is necessary to suppress unnecessary light components outputted from the optical intensity modulation section 2003 in order to obtain an angle-modulated signal that has desirable distortion characteristics when demodulated.

In order to address the problem, a conventional optical SSB modulation device disclosed in Japanese Laid-Open Patent Publication No. 2004-302238 (hereinafter referred to as “Patent Document 2”) performs a control as follows for the fluctuations over time of the optimal point of operation due to DC drift, or the like. FIG. 15 is a block diagram showing a configuration of a conventional optical SSB modulation device. Referring to FIG. 15, the optical SSB modulation device includes an optical input terminal 3000, an optical output terminal 3005, an optical SSB modulator 3003 including a pair of modulation electric signal input terminals 3004a and 3004b, a power supply 3001, and a voltage control circuit 3002.

FIG. 16 shows a block diagram showing an internal configuration of the optical SSB modulator 3003. Referring to FIG. 16, the optical SSB modulator 3003 includes an optical input terminal 3010, an optical output terminal 3011, sub-interferometers 3013a and 3013b, a main interferometer 3012c, RF electrodes 3014a, 3014b and 3014c, DC electrodes 3015a, 3015b and 3015c, and Y branches 3016, 3017a, 3017b, 3018a, 3018b and 3019.

Referring to FIGS. 15 and 16, the optical input terminal 3000 of the optical SSB modulation device receives carrier light generated from a light source such as an LD (laser diode), and electric signals, with which the carrier light is to be modulated, are applied to the pair of modulation electric signal input terminals 3004a and 3004b. The modulated output light from the optical SSB modulator 3003 is outputted from the optical output terminal 3005.

The voltage control circuit 3002 monitors a portion of the modulated output light, and controls the bias voltage generated by the power supply 3001. The bias voltage thus controlled is applied to the optical SSB modulator 3003 via the power supply 3001. Thus, the voltage control circuit 3002 monitors a portion of the output light from the optical SSB modulator 3003 to detect the power of the angular frequency component and to output a control signal for controlling the bias voltages to be applied to the sub-interferometers 3013a and 3013b and the main interferometer 3012c of the optical SSB modulator 3003. Specifically, the voltage control circuit 3002 controls the bias voltages to be applied to the sub-interferometers 3013a and 3013b so that the power of the carrier light, among other output light components, is minimized and controls the bias voltage to be applied to the main interferometer 3012c so that the power of the unnecessary sideband light, among other output light components, is minimized.

Patent Document 2 also discloses configurations as shown in FIGS. 17 and 18, as conventional optical SSB modulation devices. As compared with the configuration shown in FIG. 15, the conventional optical SSB modulation device shown in FIG. 17 further includes an optical filter 3006 for separating the modulated output light outputted from the optical output terminal 3005 into angular frequency components. Referring to FIG. 17, a portion of the modulated output light from the optical SSB modulator 3003 is separated by the optical filter 3006 into carrier light and unnecessary sideband light components. The voltage control circuit 3002 monitors the power of the carrier light, and controls the power supply 3001 so that the DC electrodes 3015a and 3015b of the sub-interferometers 3013a and 3013b receives bias voltages such that the power of the carrier light is minimized. The voltage control circuit 3002 monitors the power of the unnecessary sideband light, and controls the power supply 3001 so that the DC electrode 3015c of the main interferometer 3012c receives a bias voltage such that the power of the unnecessary sideband light is minimized.

As compared with the configuration shown in FIG. 15, the conventional optical SSB modulation device shown in FIG. 18 further includes a PD (photodetector) 3007 for converting a portion of the modulated output light from the optical output terminal 3005 to an electric signal. Referring to FIG. 18, a portion of the modulated output light from the optical SSB modulator 3003 is converted by the PD 3007 to an electric signal. The voltage control circuit 3002 monitors the carrier light component based on the electric signal, and controls the power supply 3001 so that the DC electrodes 3015a and 3015b of the sub-interferometers 3013a and 3013b receive bias voltages such that the power of the carrier light is minimized. The voltage control circuit 3002 monitors the unnecessary sideband light component based on the electric signal, and controls the power supply 3001 so that the DC electrode 3015c of the main interferometer 3012c receives a bias voltage such that the power of the unnecessary sideband light is minimized. Thus, as does the two conventional devices described above, the optical SSB modulation device shown in FIG. 18 is capable of always producing a practical, high-quality optical SSB-modulated signal.

The conventional optical SSB modulation device shown in FIG. 18 controls the bias voltages based on respective signal components, i.e., the carrier light converted by the PD to an electric signal and the unnecessary sideband light, whereby it is possible to always output a high-quality SSB-modulated optical signal without being influenced by DC drift. Thus, there is an advantageous effect that the reliability of optical communications is practically improved. Moreover, the device can be realized with a simple configuration because the power of the carrier light and that of the unnecessary sideband light can be monitored with a simple configuration such as a PD.

With the conventional optical SSB modulation devices shown in FIGS. 15 and 17 to 18, the power of the carrier light and that of the unnecessary sideband light from the optical SSB modulator 3003 need to be monitored in order to control the bias voltages to be applied to the sub-interferometers 3013a and 3013b and the main interferometer 3012c. However, the monitoring cannot always be done successfully. Specifically, with the conventional optical SSB modulation device shown in FIG. 15, the power of the carrier light and that of the unnecessary sideband light from the optical SSB modulator 3003 are not separated from each other, whereby it is impossible to control the bias voltages by monitoring the power of each light component.

With the conventional optical SSB modulation device shown in FIG. 17, the optical filter 3006 is provided in order to separate the power of the carrier light and that of the unnecessary sideband light from the optical SSB modulator 3003 from each other. A conventional optical filter can be used where the frequency of the electric signal inputted to the optical SSB modulator 3003 is sufficiently high (e.g., 40 GHz or more). However, where the frequency of the input signal is on the order of 1 GHz, there is no existing optical filter capable of separating light components arranged with small intervals therebetween. Therefore, where the optical SSB modulator 3003 is driven with an input signal whose frequency is on the order of 1 GHz, it is impossible to control the bias voltages by monitoring the power of the carrier light and that of the unnecessary sideband light. With the conventional optical SSB modulation device shown in FIG. 18, the carrier light and unnecessary sideband light components need to be converted back to electric signals by the PD 3007 so that the power can be monitored in terms of the power of each electric signal. This cannot be done if the light components cannot be separated from each other.

### SUMMARY OF THE INVENTION

Therefore, an object of the present invention is to provide specific means for optimally controlling bias voltages even if DC drift occurs where the frequency of the electric signal inputted to the optical SSB modulator is relatively low (on the order of 1 GHz), and to realize a wideband modulated signal generating device having desirable modulation characteristics.

The present invention is directed to a wide band modulated signal generating device. In order to attain the object set forth above, a first aspect of the present invention is directed to a wideband modulated signal generating device, including: a light source for outputting light; a light branching section for splitting the light outputted from the light source into first light and second light; an optical intensity modulation section for subjecting the first light to an optical intensity modulation or an optical amplitude modulation with an original signal being a first electric signal having a predetermined frequency f_{C} to output a resultant signal as a first optical signal; an optical angle modulation section for subjecting the second light to an optical angular modulation with an original signal being a second electric signal to output a resultant signal as a second optical signal; a light combining section for combining together the first optical signal and the second optical signal; a light detecting section having squared detection characteristics for converting an optical signal outputted from the light combining section to an electric signal to thereby output a wideband modulated signal having a carrier frequency f_{C} with an original signal being the second electric signal; first, second and third DC power supplies for applying first, second and third bias voltages, respectively, to the optical intensity modulation section; and a bias voltage control section for controlling the first bias voltage and the second bias voltage applied by the first and second DC power supplies to the optical intensity modulation section based on a level of an electric signal having an arbitrary frequency included in the wideband modulated signal outputted from the light detecting section, and controlling the third bias voltage applied by the third DC power supply to the optical intensity modulation section based on a level of a distortion component at an arbitrary frequency included in a demodulated electric signal outputted from the light combining section.

According to the first aspect of the present invention, the first bias voltage and the second bias voltage are controlled based on the level of the electric signal having an arbitrary frequency included in the wideband modulated signal outputted from the light detecting section, and the third bias voltage is controlled based on the level of the distortion component at an arbitrary frequency included in the electric signal outputted from the light combining section and demodulated, whereby it is possible to follow the fluctuations of the optimal point of each bias voltage due to DC drift, or the like, and it is possible to produce a wideband modulated signal with desirable modulation characteristics.

In a second aspect of the present invention, the bias voltage control section controls the first DC power supply and the second DC power supply to set the first bias voltage and the second bias voltage each to a predetermined bias voltage value, and then controls the third DC power supply to set the third bias voltage to a predetermined bias voltage.

According to the second aspect of the present invention, with regard to the flow of controlling a plurality of bias voltages, the third bias voltage is controlled after the first and second bias voltages are controlled in view of the characteristics of the optical intensity modulation section, thus realizing an efficient bias voltage control.

In a third aspect of the present invention, the bias voltage control section includes: a branching section for branching a portion of the electric signal from the light detecting section into two paths; a signal level detecting section for extracting a component of one of the electric signals from the branching section that is within a particular band and measuring a level of the component to detect the level of an electric signal having an arbitrary frequency included in a wideband modulated signal outputted from the light detecting section; a demodulation section for demodulating a wideband modulated signal included in the other one of the electric signals from the branching section; a distortion level detecting section for detecting a level of a distortion component at an arbitrary frequency included in a wideband modulated signal outputted from the demodulation section; and a bias voltage control section for controlling the first bias voltage and the second bias voltage applied by the first DC power supply and the second DC power supply, respectively, to the optical intensity modulation section so that the level of the electric signal having an arbitrary frequency detected by the signal level detecting section is less than or equal to a reference level, and controlling the third bias voltage applied by the third DC power supply to the optical intensity modulation section so that the level of the distortion component at an arbitrary frequency detected by the distortion level detecting section is less than or equal to a reference level.

According to the third aspect of the present invention, the first and second bias voltages are controlled so that the level of the electric signal having an arbitrary frequency detected by the signal level detecting section is less than or equal to a reference level, and the third bias voltage is controlled so that the level of the distortion component at an arbitrary frequency detected by the distortion level detecting section is less than or equal to a reference level, whereby it is possible to produce an always stable wideband modulated signal.

In a fourth aspect of the present invention, the signal level detecting section detects a level of a component of the second electric signal that has a lowest frequency.

According to the fourth aspect of the present invention, signal level detecting section detects a component of the second electric signal that has the lowest frequency, whereby it is possible to easily detect the level of an electric signal having an arbitrary frequency included in the wideband modulated signal.

In a fifth aspect of the present invention, the distortion level detecting section detects a distortion component occurring within a signal band of a highest frequency among other components of the second electric signal inputted to the optical angle modulation section.

According to the fifth aspect of the present invention, the distortion level detecting section detects a distortion for a high frequency band, where the deterioration of the distortion characteristics is most pronounced, whereby it is possible to realize a bias voltage control with a high precision.

In a sixth aspect of the present invention, where the second electric signal includes modulated signals of different modulation schemes, the distortion level detecting section detects a distortion component occurring within a signal band of a highest frequency among other components of the second electric signal that has been modulated by a modulation scheme for which the highest performance is required.

According to the sixth aspect of the present invention, the distortion level detecting section detects the distortion within a signal band of the highest frequency among other components of a signal for which a predetermined performance is required strictly, whereby it is possible to realize a bias voltage control with a higher precision.

In a seventh aspect of the present invention, a third electric signal is additionally superposed over the second electric signal inputted to the optical angle modulation section, and the signal level detecting section detects a level of the third electric signal.

According to the seventh aspect of the present invention, even if the second electric signal is composed only of modulated components, the signal level detecting section detects an unmodulated third electric signal as a monitor signal, whereby it is possible to realize a bias voltage control with a higher precision. Since the level and the frequency of the third monitor electric signal can be determined arbitrarily, it is possible to realize a signal level detecting section more inexpensively with a simple configuration.

In an eighth aspect of the present invention, the third electric signal has a frequency lower than that of the second electric signal.

According to the eighth aspect of the present invention, since the third electric signal has a frequency lower than that of the second electric signal, it is possible to more easily detect the level of the electric signal having an arbitrary frequency included in the wideband modulated signal if the signal level detecting section uses the third electric signal as a monitor signal.

In a ninth aspect of the present invention, the distortion level detecting section detects a distortion component produced by a fourth electric signal and a fifth electric signal when the fourth and fifth electric signals are superposed over the second electric signal inputted to the optical angle modulation section.

According to the ninth aspect of the present invention, even if the second electric signal is composed only of modulated components, the distortion level detecting section detects a distortion component produced by the unmodulated fourth and fifth electric signals, whereby it is possible to realize a bias voltage control with a higher precision. Since the level and the frequency of the fourth and fifth electric signals can be determined arbitrarily, it is possible to realize a distortion level detecting section more inexpensively with a simple configuration.

In a tenth aspect of the present invention, the fourth and fifth electric signals have frequencies such that a distortion component produced by the fourth electric signal and the fifth electric signal is not within a signal band of the second electric signal.

According to the tenth aspect of the present invention, the frequencies of the fourth and fifth electric signals are selected so that a distortion does not occur within a signal band of the second electric signal, whereby it is possible to produce a wideband modulated signal of a higher quality.

In an eleventh aspect of the present invention, the bias voltage control section includes: a first branching section for branching a portion of the electric signal from the light detecting section; a demodulation section for demodulating a wideband modulated signal included in an electric signal outputted from the first branching section; a second branching section for branching an electric signal outputted from the demodulation section into two paths; a signal level detecting section for detecting a level of an electric signal having an arbitrary frequency included in one of the wideband modulated signals outputted from the second branching section; a distortion level detecting section for detecting a level of a distortion component at an arbitrary frequency included in the other one of the wideband modulated signals outputted from the second branching section; and a bias voltage control section for controlling the first bias voltage and the second bias voltage applied by the first DC power supply and the second DC power supply, respectively, to the optical intensity modulation section so that the level of the electric signal having an arbitrary frequency detected by the signal level detecting section is less than or equal to a reference level, and controlling the third bias voltage applied by the third DC power supply to the optical intensity modulation section so that the level of the distortion component at an arbitrary frequency detected by the distortion level detecting section is less than or equal to a reference level.

According to the eleventh aspect of the present invention, the first and second bias voltages are controlled so that the level of the electric signal having an arbitrary frequency detected by the signal level detecting section is less than or equal to a reference level, and the third bias voltage is controlled so that the level of the distortion component at an arbitrary frequency detected by the distortion level detecting section is less than or equal to a reference level, whereby it is possible to produce an always stable wideband modulated signal.

In a twelfth aspect of the present invention, the signal level detecting section detects a level of a component of the second electric signal that has a frequency twice as high as a lowest frequency thereof.

According to the twelfth aspect of the present invention, the signal level detecting section detects a frequency component that is twice as high as that of a component of the second electric signal having the lowest frequency, whereby it is possible to easily detect the level of the electric signal having an arbitrary frequency included in the wideband modulated signal.

In a thirteenth aspect of the present invention, the distortion level detecting section detects a distortion component occurring within a signal band of a highest frequency among other components of the second electric signal inputted to the optical angle modulation section.

According to the thirteenth aspect of the present invention, the distortion level detecting section detects a distortion for a high frequency band, where the deterioration of the distortion characteristics is most pronounced, whereby it is possible to realize a bias voltage control with a high precision.

In a fourteenth aspect of the present invention, where the second electric signal includes modulated signals of different modulation schemes, the distortion level detecting section detects a distortion component occurring within a signal band of a highest frequency among other components of the second electric signal that has been modulated by a modulation scheme for which the highest performance is required.

According to the fourteenth aspect of the present invention, the distortion level detecting section detects the distortion within a signal band of the highest frequency among other components of a signal for which a predetermined performance is required strictly, whereby it is possible to realize a bias voltage control with a higher precision.

In a fifteenth aspect of the present invention, a sixth electric signal is additionally superposed over the second electric signal inputted to the optical angle modulation section, and the signal level detecting section detects a level of an electric signal having a frequency component twice as high as that of the sixth electric signal.

According to the fifteenth aspect of the present invention, even if the second electric signal is composed only of modulated components, the signal level detecting section detects, as a monitor signal, a frequency component twice as high as that of the unmodulated sixth electric signal, whereby it is possible to realize a bias voltage control with a higher precision. Since the level and the frequency of the sixth monitor electric signal can be determined arbitrarily, it is possible to realize a signal level detecting section more inexpensively with a simple configuration.

In a sixteenth aspect of the present invention, the sixth electric signal has a frequency lower than that of the second electric signal.

According to the sixteenth aspect of the present invention, since the sixth electric signal has a frequency lower than that of the second electric signal, it is possible to more easily detect the level of the electric signal having an arbitrary frequency included in the wideband modulated signal if the signal level detecting section uses the sixth electric signal as a monitor signal.

In a seventeenth aspect of the present invention, the distortion level detecting section detects a distortion component produced by a seventh electric signal and an eighth electric signal when the seventh and eighth electric signals are superposed over the second electric signal inputted to the optical angle modulation section.

According to the seventeenth aspect of the present invention, even if the second electric signal is composed only of modulated components, the distortion level detecting section detects a distortion component produced by the unmodulated seventh and eighth electric signals, whereby it is possible to realize a bias voltage control with a higher precision. Since the level and the frequency of the seventh and eighth electric signals can be determined arbitrarily, it is possible to realize a distortion level detecting section more inexpensively with a simple configuration.

In an eighteenth aspect of the present invention, the seventh and eighth electric signals have frequencies such that a distortion component produced by the seventh electric signal and the eighth electric signal is not within a signal band of the second electric signal.

According to the eighteenth aspect of the present invention, the frequencies of the seventh and eighth electric signals are selected so that a distortion does not occur within a signal band of the second electric signal, whereby it is possible to produce a wideband modulated signal of a higher quality.

As described above, with the wideband modulated signal generating device of the present invention, bias voltages to be applied to the optical intensity modulation section are controlled based on the signal level of a particular frequency included in the wideband modulated signal and the level of the distortion component thereof, whereby it is possible to always stabilize the operation of the optical intensity modulation section without being influenced by DC drift, and thus to obtain a wideband modulated signal of a high quality. Moreover, since an optical filter, which is required in conventional configurations, is not needed in the present invention, it is possible to realize a stable operation with a simple configuration even if the input signal to the optical intensity modulation section is an electric signal whose frequency is on the order of 1 GHz, whereby it is possible to obtain a high-quality wideband modulated signal, irrespective of the frequency of the input signal to the optical intensity modulation section.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a wideband modulated signal generating device according to a first embodiment of the present invention;

FIG. 2 is a diagram showing a schematic internal configuration of an optical intensity modulation section 30 shown in FIG. 1;

FIG. 3 is a flow chart showing the process of controlling the bias voltage performed by a DC power supply control section 50;

FIG. 4 is a flow chart showing the details of the process of controlling the first bias voltage (step S100);

FIG. 5 is a flow chart showing the details of the process of controlling the second bias voltage (step S200);

FIG. 6 is a flow chart showing the details of the process of controlling the third bias voltage (step S300);

FIG. 7A is a block diagram showing a modified configuration of the wideband modulated signal generating device according to the first embodiment of the present invention;

FIG. 7B is a block diagram showing a modified configuration of the wideband modulated signal generating device according to the first embodiment of the present invention;

FIG. 8 is a block diagram showing a configuration of a wideband modulated signal generating device according to a second embodiment of the present invention;

FIG. 9A is a block diagram showing a modified configuration of the wideband modulated signal generating device according to the second embodiment of the present invention;

FIG. 9B is a block diagram showing a modified configuration of the wideband modulated signal generating device according to the second embodiment of the present invention;

FIG. 10 is a block diagram showing a configuration of a conventional wideband modulated signal generating device;

FIG. 11A is a schematic diagram showing the frequency spectrum of an optical signal outputted from a local light source 902;

FIG. 11B is a schematic diagram showing the frequency spectrum of an optical signal outputted from an optical modulation section 903;

FIG. 11C is a schematic diagram showing the frequency spectrum of a signal outputted from a light detecting section 905;

FIG. 12 is a block diagram showing a configuration of a conventional wideband modulated signal generating device;

FIG. 13A is a diagram showing the frequency spectrum of an optical signal outputted from an optical intensity modulation section 2003;

FIG. 13B is a diagram showing the frequency spectrum of an optical signal outputted from an optical angle modulation section 2004;

FIG. 13C is a diagram showing the frequency spectrum of an electric signal outputted from a light detecting section 2006;

FIG. 14A is a diagram showing the relationship between the degree of carrier suppression and the distortion characteristics;

FIG. 14B is a diagram showing the relationship between the degree of sideband suppression and the distortion characteristics;

FIG. 15 is a block diagram showing a configuration of a conventional optical SSB modulation device;

FIG. 16 is a block diagram showing an internal configuration of an optical SSB modulator 3003;

FIG. 17 is a block diagram showing a configuration of a conventional optical SSB modulation device; and

FIG. 18 is a block diagram showing a configuration of a conventional optical SSB modulation device.

### DESCRIPTION OF THE PREFERRED EMBODIMENTS

Wideband modulated signal generating devices according to preferred embodiments of the present invention will now be described with reference to the drawings. It is understood that the scope of the present invention is not limited to these preferred embodiments.

### First Embodiment

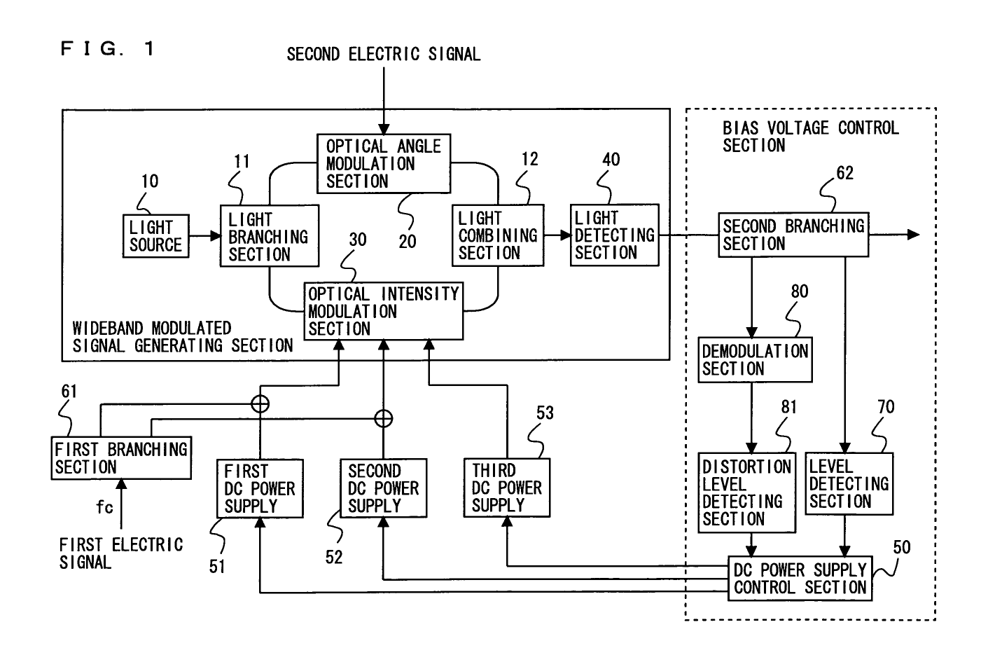

FIG. 1 is a block diagram showing a configuration of a wideband modulated signal generating device according to a first embodiment of the present invention. Referring to FIG. 1, the wideband modulated signal generating device includes a light source 10, a light branching section 11, a light combining section 12, an optical angle modulation section (an optical phase modulation section) 20, an optical intensity modulation section 30, a light detecting section 40, a DC power supply control section 50, a first DC power supply 51, a second DC power supply 52, a third DC power supply 53, a first branching section 61, a second branching section 62, a level detecting section 70, a demodulation section 80, and a distortion level detecting section 81. The light source 10, the light branching section 11, the light combining section 12, the optical angle modulation section 20, the optical intensity modulation section 30 and the light detecting section 40 may be referred to collectively as the “wideband modulated signal generating section”. Similarly, the DC power supply control section 50, the second branching section 62, the level detecting section 70, the demodulation section 80 and the distortion level detecting section 81 may be referred to collectively as the “bias voltage control section”.

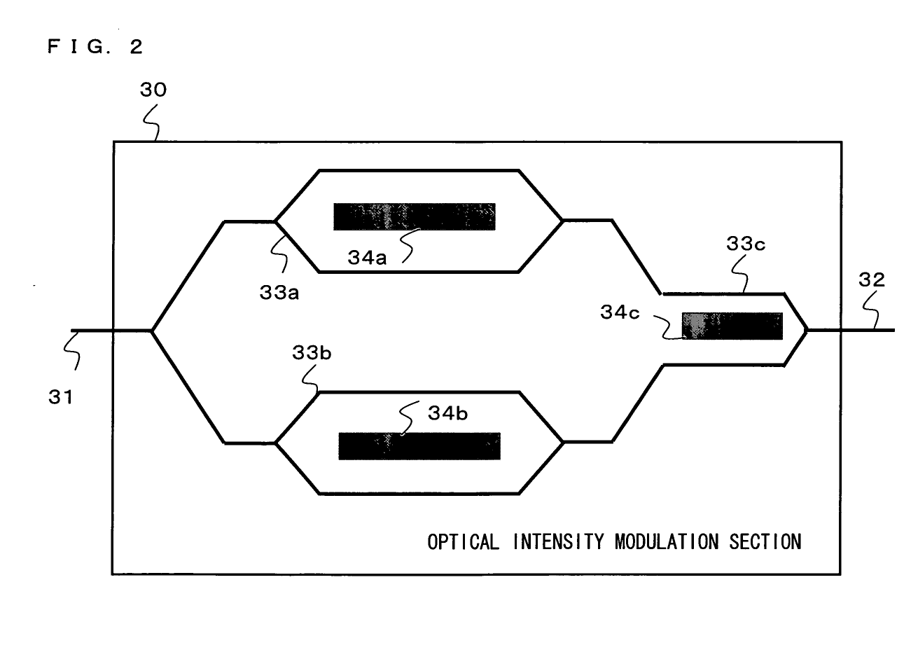

FIG. 2 is a diagram showing a schematic internal configuration of the optical intensity modulation section 30. For example, the optical intensity modulation section 30 includes an optical input terminal section 31, an optical output terminal 32, a first MZ interferometer 33a, a second MZ interferometer 33b, a third MZ interferometer 33c, a first electrode section 34a of the first MZ interferometer 33a, a second electrode section 34b of the second MZ interferometer 33b, and a third electrode section 34c of the third MZ interferometer 33c, as shown in FIG. 2.

The flow of signals in the wideband modulated signal generating device will now be described. The light branching section 11 splits the unmodulated light from the light source 10 into first light and second light. The first light is inputted to the optical intensity modulation section 30. In the optical intensity modulation section 30 shown in FIG. 2, the first light outputted from the light branching section 11 is inputted to the two MZ interferometers 33a and 33b via the optical input terminal section 31. The two MZ interferometers 33a and 33b modulate the input first light with two electric signals, which are obtained by superposing an electric signal having a predetermined frequency f_{C} from the first branching section 61 over the first bias voltage from the first DC power supply 51 and the second bias voltage from the second DC power supply 52.

Then, the optically modulated signal from the first MZ interferometer 33a and that from the second MZ interferometer 33b are given predetermined phases in the third MZ interferometer 33c by the third bias voltage from the third DC power supply 53 and are made to interfere with each other. Thus, the optical intensity modulation section 30 subjects the input first light to an optical intensity modulation (or an optical amplitude modulation) based on the amplitude of the first electric signal having a predetermined frequency f_{C} to output the resultant signals as the first optically modulated signal.

The second light is inputted to the optical angle modulation section 20. The optical angle modulation section 20 subjects the input second light to an optical angular modulation (an optical phase modulation or an optical frequency modulation) based on the amplitude of the second electric signal to output the resultant signal as the second optically modulated signal. The light combining section 12 combines together the first optically modulated signal from the optical intensity modulation section 30 and the second optically modulated signal from the optical angle modulation section 20. The light detecting section 40 may be a photodiode having squared detection characteristics, or the like. Using the squared detection characteristics, the light detecting section 40 homodyne-detects the first optically modulated signal and the second optically modulated signal from the light combining section 12 to thereby produce a difference beat signal therebetween. The difference beat signal is a wideband modulated signal obtained by down-converting the second optically modulated signal from the optical angle modulation section 20 and subjecting the signal to an angular modulation, and has a center frequency of f_{C}.

The second branching section 62 branches a portion of the electric signal from the light detecting section 40 into two paths. The level detecting section 70 extracts a component within a particular band from one of the electric signals from the second branching section 62 and measures the level of the extracted component to thereby detect the level of an electric signal having an arbitrary frequency included in the wideband modulated signal outputted from the light detecting section 40. Particularly, the level detecting section 70 simply detects the level of the electric signal having an arbitrary frequency included in the wideband modulated signal by detecting the signal component of the lowest frequency among other components of the second electric signal.

The demodulation section 80 demodulates the wideband modulated signal included in the other one of the electric signals from the second branching section 62. The distortion level detecting section 81 detects the level of the distortion component at an arbitrary frequency included in the wideband modulated signal from the demodulation section 80. Particularly, the distortion level detecting section 81 detects the distortion component occurring within a signal band of the highest frequency (where the deterioration of the distortion characteristics is most pronounced) among other components of the second electric signal, whereby it is possible to realize a bias control with a higher precision. Where the second electric signal includes modulated signals of different modulation schemes, the distortion level detecting section 81 detects the distortion component occurring within a signal band of the highest frequency among other components of a modulated signal (among other signals of the second electric signal) that has been modulated by a modulation scheme for which the highest performance is required, whereby it is possible to realize a bias control with a higher precision. The DC power supply control section 50 controls the first bias voltage to be applied to the first DC power supply 51, the second bias voltage to be applied to the second DC power supply 52 and the third bias voltage to be applied to the third DC power supply 53 based on the signal level detected by the level detecting section 70 and the distortion level detected by the distortion level detecting section 81.

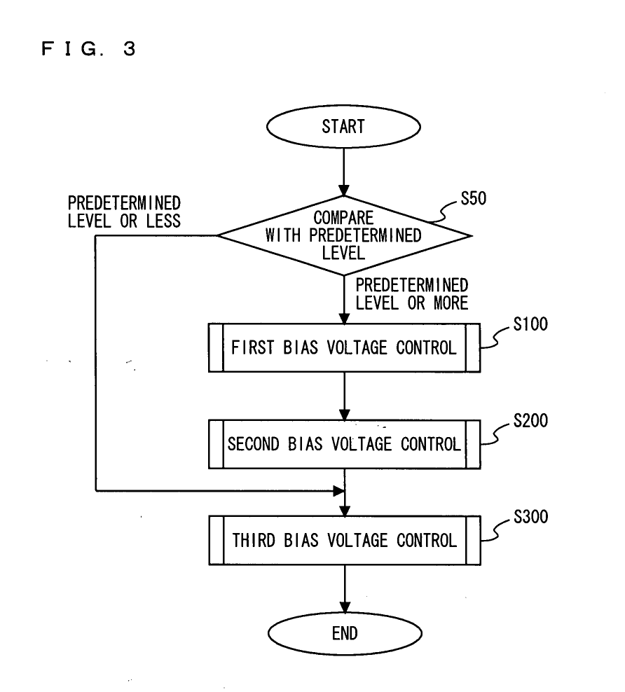

The method for controlling the bias voltages in the wideband modulated signal generating device of the present invention will now be described. Specifically, the method by which the first bias voltage, the second bias voltage and the third bias voltage are controlled by the DC power supply control section 50 will now be described in detail with reference to the flow charts shown in FIGS. 3 to 6.

FIG. 3 is a flow chart showing the process of controlling the bias voltage performed by the DC power supply control section 50. Referring to FIG. 3, the DC power supply control section 50 compares the signal level detected by the level detecting section 70 with a predetermined signal level prestored in a memory, or the like (step S50). If it is determined that the signal level detected by the level detecting section 70 is less than or equal to the predetermined signal level, the process proceeds to step S300 (the process of controlling the third bias voltage), skipping steps S100 and S200 (the process of controlling the first bias voltage and the process of controlling the second bias voltage). If it is determined that the signal level detected by the level detecting section 70 is greater than the predetermined signal level, the process proceeds to step S100 (the process of controlling the first bias voltage).

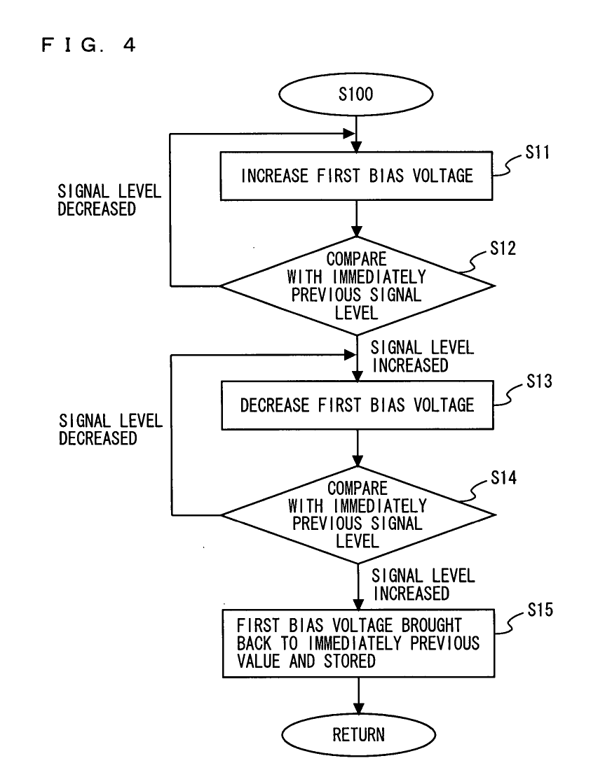

FIG. 4 is a flow chart showing the details of the process of controlling the first bias voltage (step S100). Referring to FIG. 4, the DC power supply control section 50 increases the first bias voltage by a predetermined voltage value (step S11). After the first bias voltage is increased, the DC power supply control section 50 compares the signal level re-detected by the level detecting section 70 with the previously detected signal level (step S12). If it is determined that the signal level re-detected by the level detecting section 70 has increased from the previous signal level, the process proceeds to step S13. If it is determined that the signal level re-detected by the level detecting section 70 has decreased from the previous signal level, the process returns to step S11 to repeat the same procedure. This procedure is repeated until the signal level re-detected by the level detecting section 70 is higher than the immediately previous signal level.

Then, the DC power supply control section 50 decreases the first bias voltage value by a predetermined voltage value (step S13). After the bias voltage is decreased, the DC power supply control section 50 compares the signal level re-detected by the level detecting section 70 with the previously detected signal level (step S14). If it is determined that the signal level re-detected by the level detecting section 70 has increased from the previous signal level, the process proceeds to step S15. If it is determined that the signal level re-detected by the level detecting section 70 has decreased from the previous signal level, the process returns to step S13 to repeat the same procedure. This procedure is repeated until the signal level re-detected by the level detecting section 70 is higher than the immediately previous signal level. Then, the DC power supply control section 50 brings the first bias voltage value back to the immediately previous value and stores the first bias voltage value, and exits the control of step S100 (step S15).

After step S100, the process proceeds to step S200 (the second bias voltage control) as shown in FIG. 3. FIG. 5 is a flow chart showing the details of the process of controlling the second bias voltage (step S200). Steps S100 and S200 are the same process except that bias voltages to be controlled are different from each other, and therefore step S200 will not be further described below. Note that there is no specific order in which step S100 (the process of controlling the first bias voltage) and step S200 (the process of controlling the second bias voltage) should be performed, and substantially the same results are obtained when step S100 (the process of controlling the first bias voltage) and step S200 (the process of controlling the second bias voltage) are performed in the reverse order.

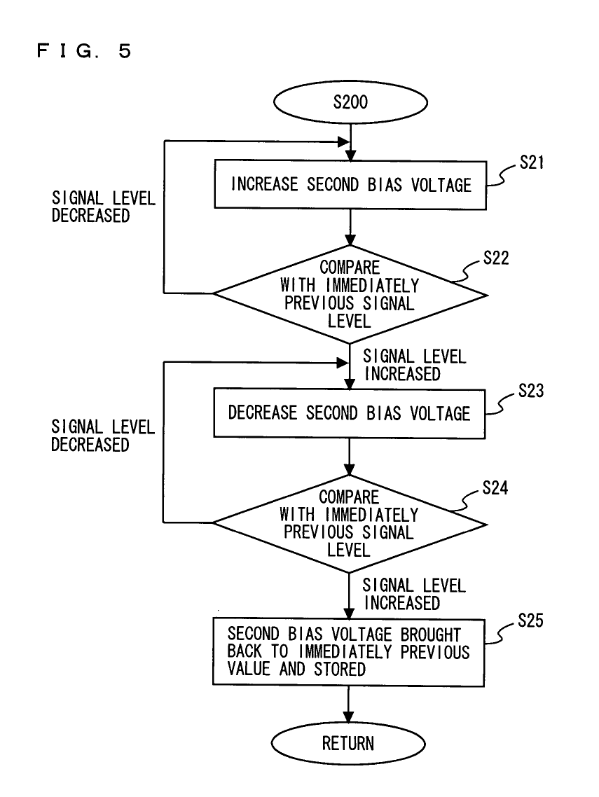

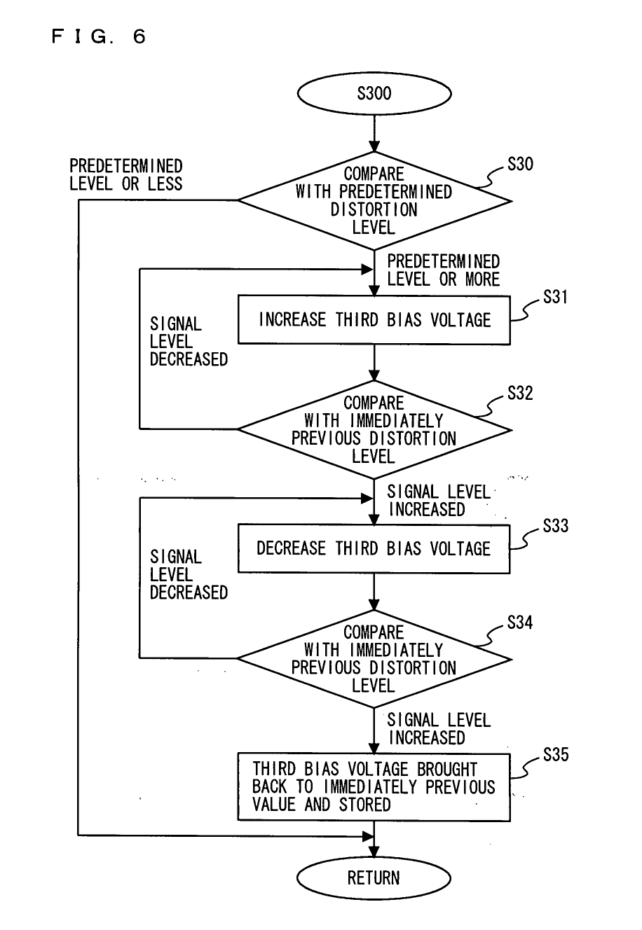

After step S200, the process proceeds to step S300 (the process of controlling the third bias voltage). FIG. 6 is a flow chart showing the details of the process of controlling the third bias voltage (step S300). Referring to FIG. 6, the DC power supply control section 50 compares the distortion level detected by the distortion level detecting section 81 with a predetermined distortion level prestored in a memory, or the like (step S30). If it is determined that the distortion level detected by the distortion level detecting section 81 is less than or equal to the predetermined distortion level, the control of step S300 is terminated while holding the value of the third bias voltage.

If it is determined that the distortion level detected by the distortion level detecting section 81 is greater than the predetermined distortion level, the process proceeds to step S31, where the value of the third bias voltage is increased by a predetermined voltage value (step S31). After the third bias voltage is increased, the DC power supply control section 50 compares the distortion level re-detected by the distortion level detecting section 81 with the immediately previous distortion level (step S32). If it is determined that the distortion level re-detected by the distortion level detecting section 81 has increased from the previous distortion level, the process proceeds to step S33. If it is determined that the distortion level re-detected by the distortion level detecting section 81 has decreased from the previous distortion level, the process returns to step S31 to repeat the same procedure. This procedure is repeated until the distortion level re-detected by the distortion level detecting section 81 is higher than the immediately previous distortion level.

Then, the DC power supply control section 50 decreases the third bias voltage value by a predetermined voltage value (step S33). After the bias voltage is decreased, the distortion level re-detected by the distortion level detecting section 81 is compared with the immediately previous distortion level (step S34). If it is determined that the distortion level re-detected by the distortion level detecting section 81 has increased from the previous distortion level, the process proceeds to step S35. If it is determined that the distortion level re-detected by the distortion level detecting section 81 has decreased from the previous distortion level, the process returns to step S33 to repeat the same procedure. This procedure is repeated until the distortion level re-detected by the distortion level detecting section 81 is higher than the immediately previous distortion level. Then, the DC power supply control section 50 brings the third bias voltage value back to the immediately previous value and stores the third bias voltage value, and exits the control of step S300 (step S35).

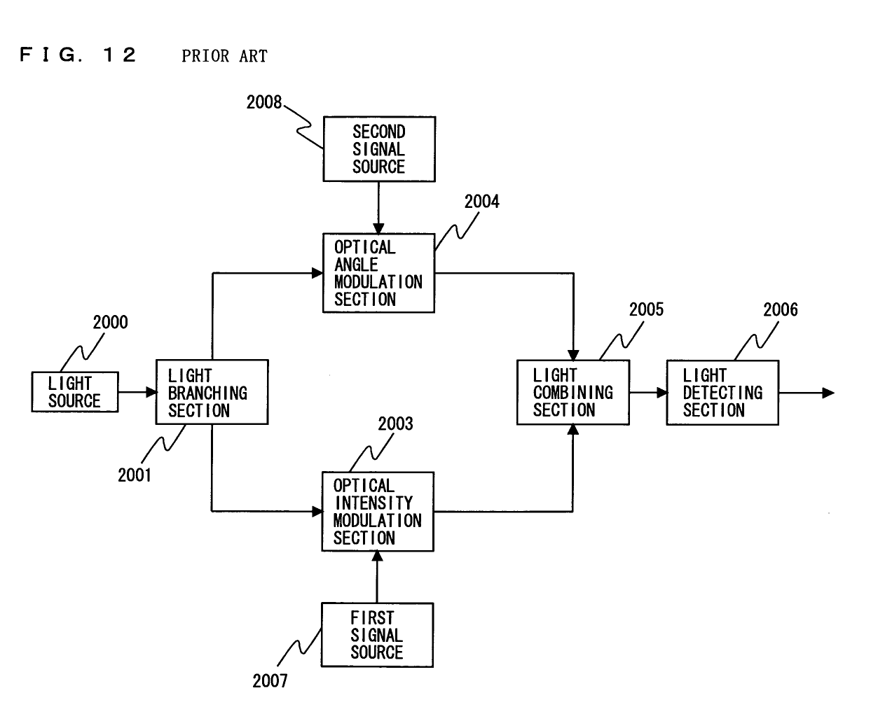

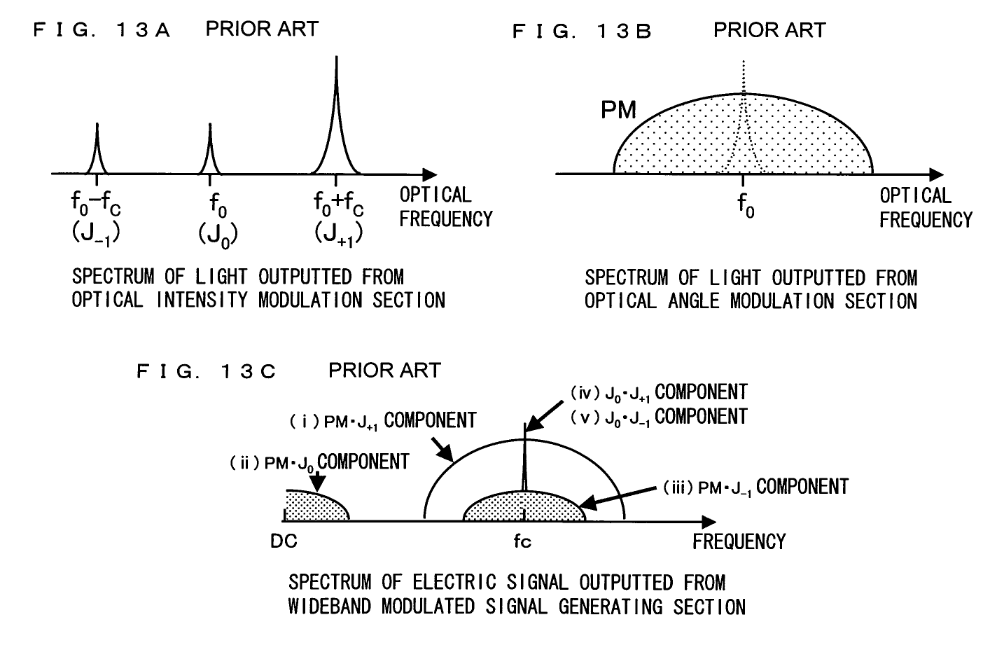

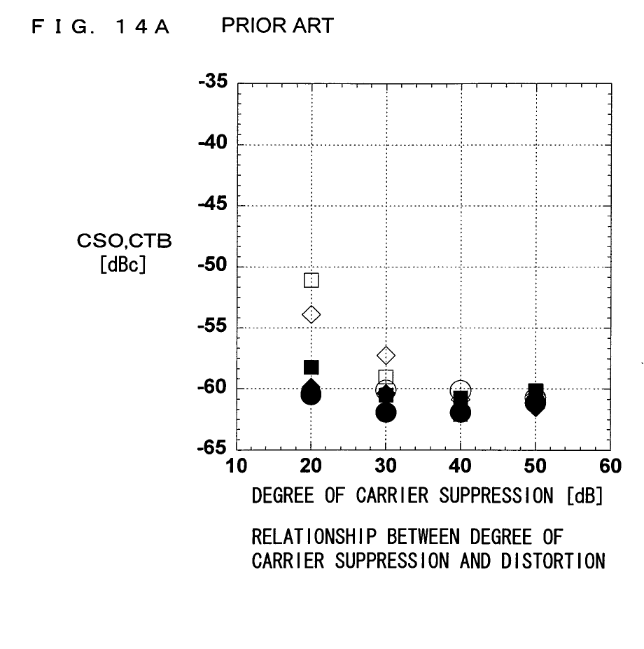

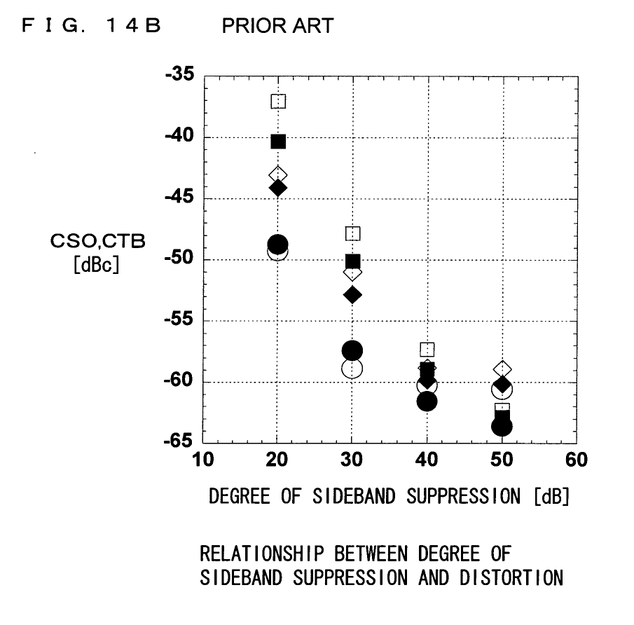

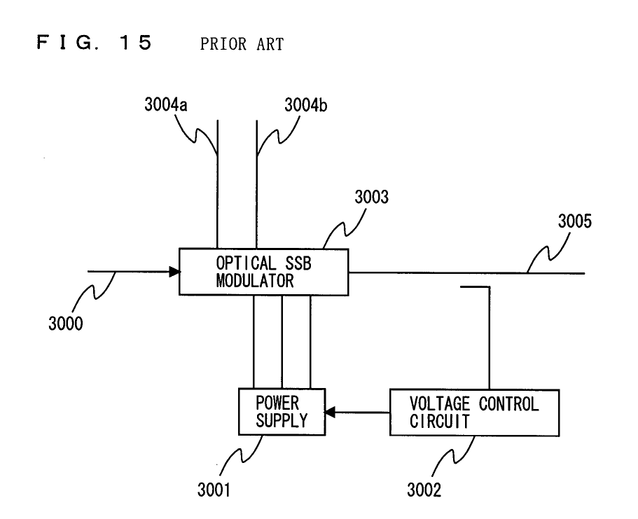

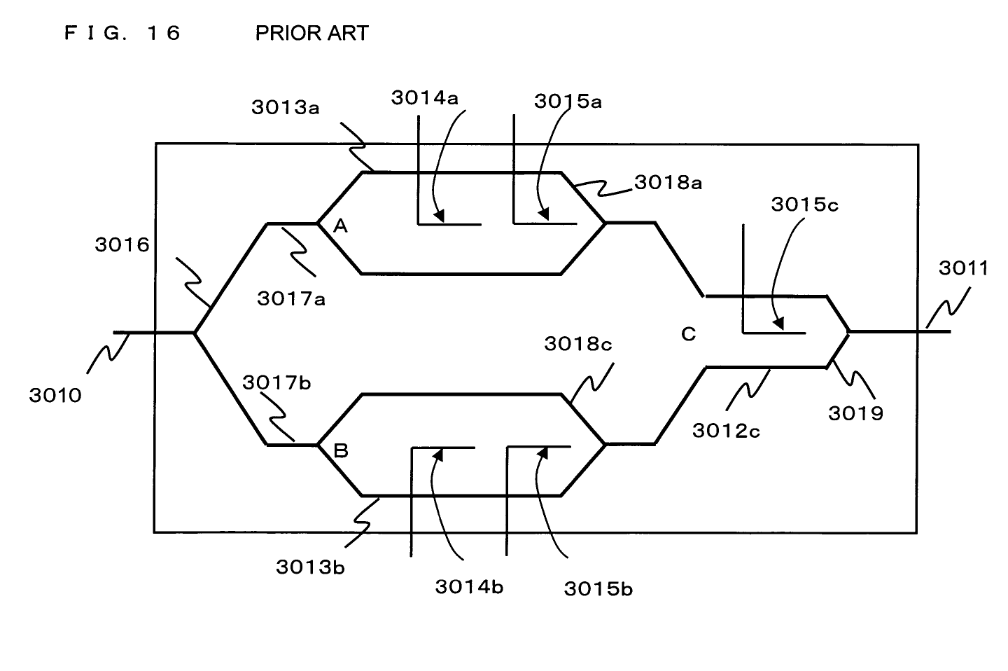

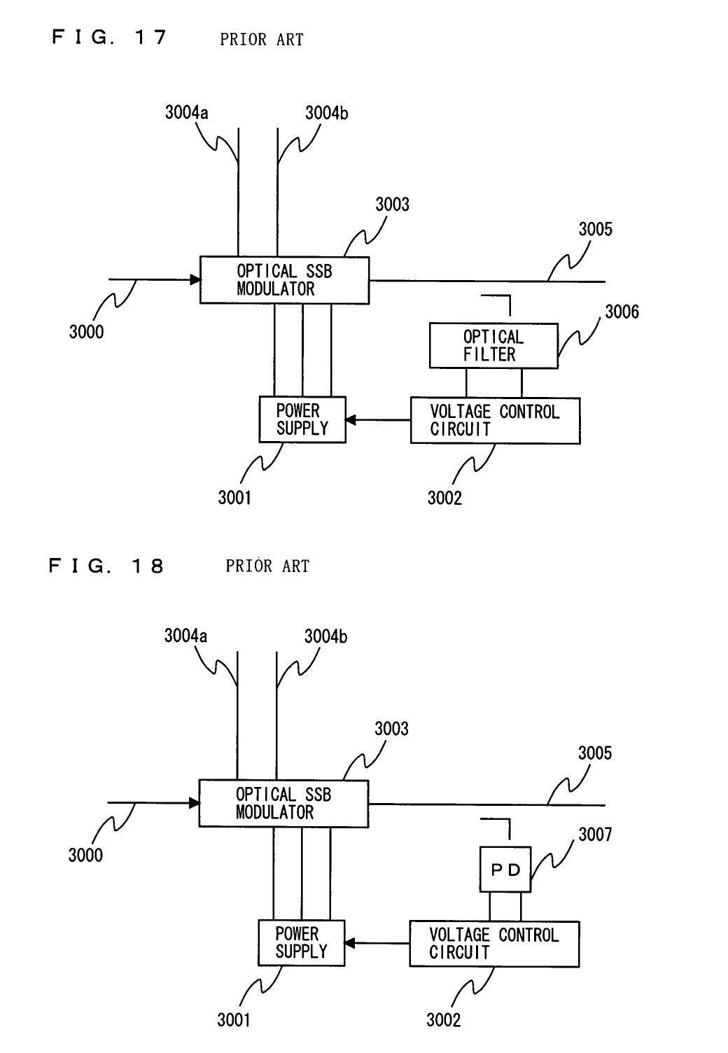

The order of the voltage control operations (steps S100, S200 and S300) will now be discussed below. The first to third bias voltages and the first electric signal are applied to the three MZ interferometers 33a, 33b and 33c of the optical intensity modulation section 30. The first MZ interferometer 33a and the second MZ interferometer 33b of the optical intensity modulation section 30 serve to suppress light from the light source 10 (i.e., the optical carrier component). The third MZ interferometer 33c serves to cancel out the single sidebands of the optically modulated signals modulated by the first MZ interferometer 33a and the second MZ interferometer 33b.

Where the first optically modulated signal component outputted from the optical intensity modulation section 30 includes, as unnecessary light components, both of the optical carrier component and the single sideband component, these components both have adverse influence on the distortion characteristics of the wideband modulated signal as described above with reference to FIGS. 14A and 14B. Nevertheless, it is inefficient to monitor the distortion component included in the wideband modulated signal to control the three bias voltages. In view of this, the DC power supply control section 50 controls the first and second bias voltages by using as a monitor signal a signal component ((ii) PM·J₀ component in FIG. 13C), among other signal components generated by the wideband modulated signal generating device, that appears in the vicinity of DC only when there remains an optical carrier component, and then controls the third bias voltage by monitoring the distortion level occurring when the wideband modulated signal is demodulated, thus realizing an efficient control flow.

The amount of time over which each bias voltage is held is set to be sufficiently short so that the bias voltage is not influenced by aging or temperature variations, and the amount by which each bias voltage is controlled is within such a range that the fluctuations of the signal level and the distortion are sufficiently small.

As described above, according to the first embodiment of the present invention, the bias control of the optical intensity modulation section 30 in the wideband modulated signal generating section is realized by detecting the signal level and the distortion level at a particular frequency outputted from the wideband modulated signal generating device, thus eliminating the need for an optical filter, which is required in conventional devices. This solves the problem that it is impossible to separate the optical carrier component and the optical sideband when demodulating an electric signal whose frequency is on the order of 1 GHz, and realizes an always stable operation with a simple configuration, whereby it is possible to provide a wideband modulated signal generating device whose modulation quality is always high.

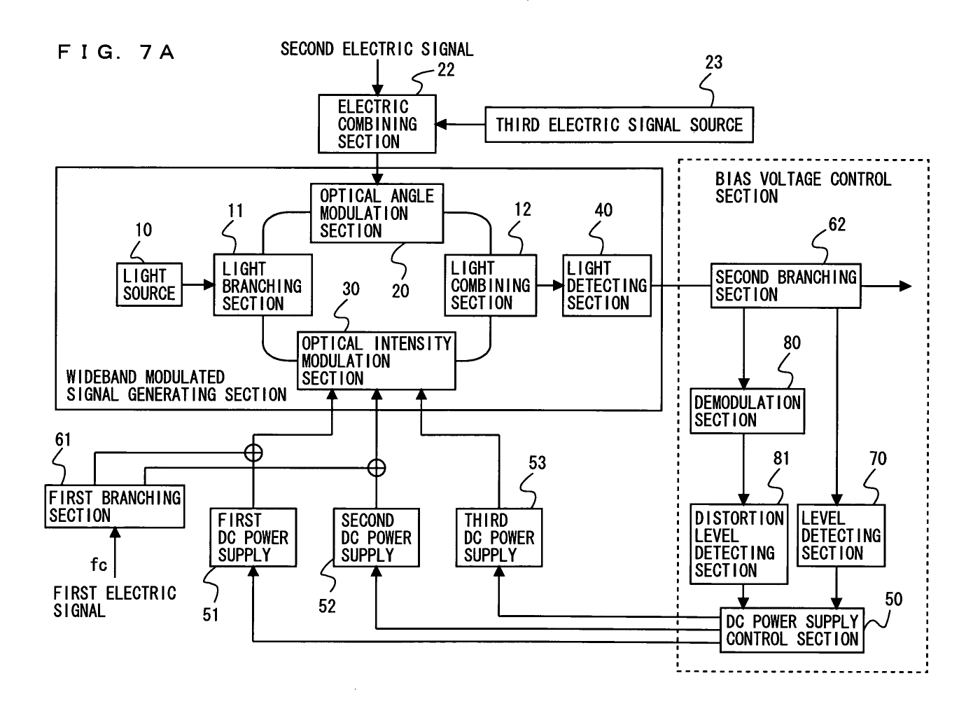

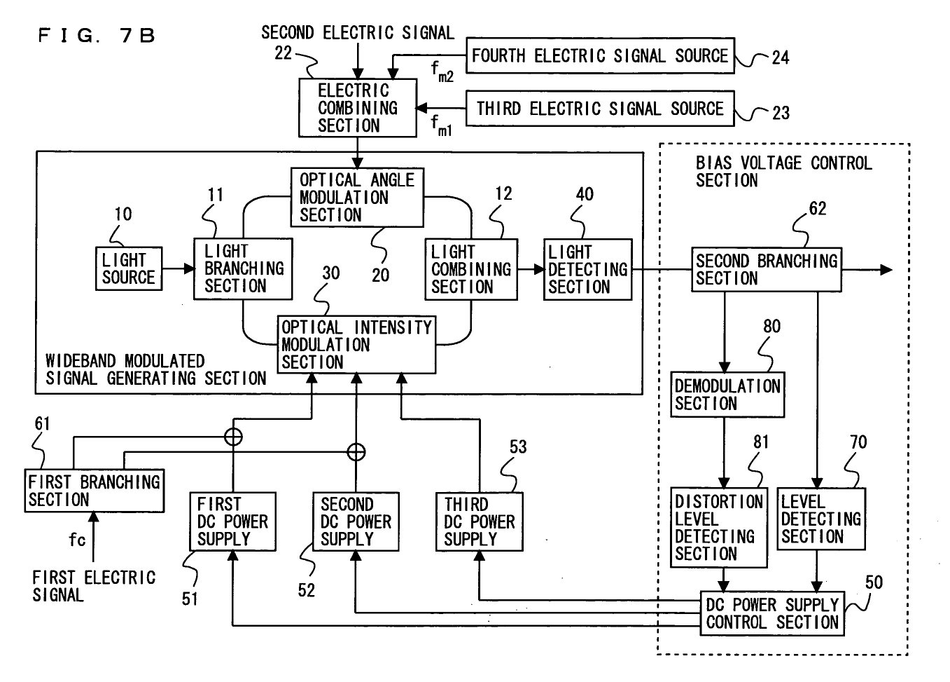

FIG. 7A shows an alternative configuration of the first embodiment. As compared with the configuration shown in FIG. 1, the wideband modulated signal generating device shown in FIG. 7A further includes an electric combining section 22 and a third electric signal source 23. The third electric signal source 23 outputs the third electric signal as a monitor electric signal to be inputted to the optical angle modulation section 20. The electric combining section 22 combines together the second electric signal and the third electric signal.

The wideband modulated signal generating device shown in FIG. 7A is the same as the configuration shown in FIG. 1 in terms of the signal flow and the process of controlling the bias voltage, and differs from the configuration shown in FIG. 1 in that the third electric signal is detected by the level detecting section 70 and used for controlling the first bias voltage and the second bias voltage. The second electric signal may in some cases be a signal composed only of modulated components, e.g., a video signal. It is possible to realize a control with a higher precision by using an unmodulated electric signal such as the third electric signal as a monitor signal, rather than by using a modulated electric signal such as the second electric signal. Then, the level and the frequency of the third monitor electric signal can be determined arbitrarily, whereby it is possible to realize the level detecting section 70 more inexpensively with a simple configuration. Moreover, by setting the frequency of the third electric signal to be lower than that of the second electric signal, it is possible to easily detect the level of the third electric signal.

FIG. 7B shows another alternative configuration of the first embodiment. As compared with the configuration shown in FIG. 7A, the wideband modulated signal generating device shown in FIG. 7B further includes a fourth electric signal source 24. The fourth electric signal source 24 outputs the fourth electric signal as a monitor electric signal to be inputted to the optical angle modulation section 20. A characteristic of this configuration is that a distortion component (fₘ₁+fₘ₂ or fₘ₂−fₘ₁) produced by the third electric signal (e.g., frequency fₘ₁) and the fourth electric signal (e.g., frequency fₘ₂) is monitored as the distortion component detected by the distortion level detecting section 81 to thereby control the third bias voltage.

The frequency of the monitor signal is preferably such that the produced distortion component does not appear within the signal band of the second electric signal inputted to the optical angle modulation section 20. As described above, the second electric signal may in some cases be a signal composed only of modulated components, e.g., a video signal. It is possible to realize a control with a higher precision by superposing together unmodulated electric signals such as the third and fourth electric signals so as to detect the distortion component produced by the two electric signals, rather than by using a modulated electric signal such as the second electric signal. Since the level and the frequency of the third and fourth monitor electric signals can be determined arbitrarily, it is possible to realize the distortion level detecting section 81 more inexpensively with a simple configuration.

### Second Embodiment

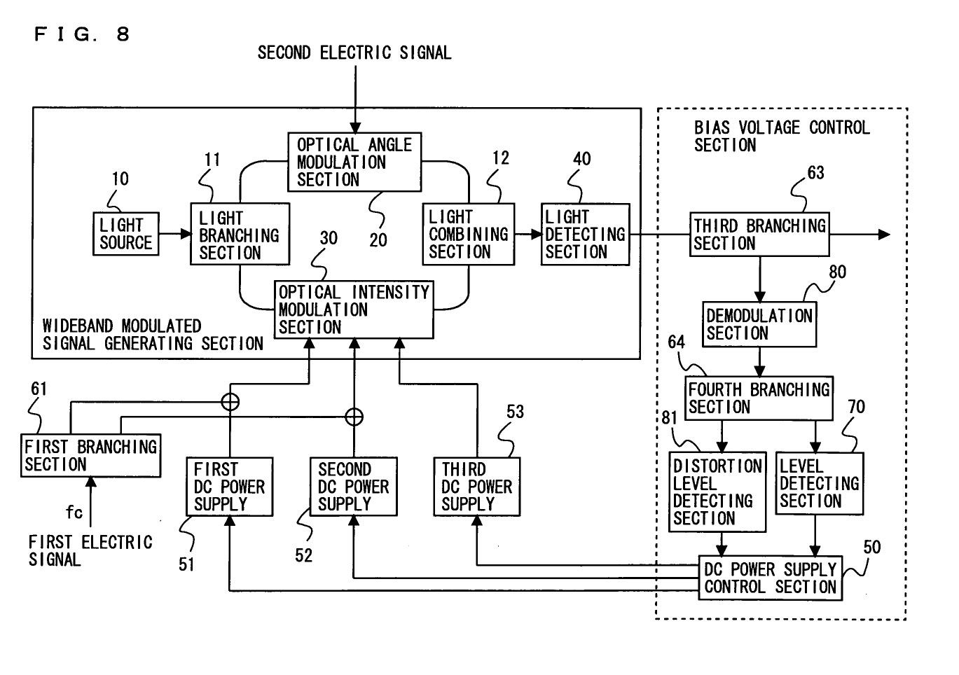

FIG. 8 is a block diagram showing a configuration of a wideband modulated signal generating device according to a second embodiment of the present invention. Referring to FIG. 8, the wideband modulated signal generating device includes the light source 10, the light branching section 11, the light combining section 12, the optical angle modulation section 20, the optical intensity modulation section 30, the light detecting section 40, the DC power supply control section 50, the first DC power supply 51, the second DC power supply 52, the third DC power supply 53, the first branching section 61, a third branching section 63, a fourth branching section 64, the level detecting section 70, the demodulation section 80, and the distortion level detecting section 81. The light source 10, the light branching section 11, the light combining section 12, the optical angle modulation section 20, the optical intensity modulation section 30 and the light detecting section 40 may be referred to collectively as the “wideband modulated signal generating section”. Similarly, the DC power supply control section 50, the third branching section 63, the demodulation section 80, the fourth branching section 64, the level detecting section 70 and the distortion level detecting section 81 may be referred to collectively as the “bias voltage control section”.

The signal flow is the same as that of the first embodiment, and will not be further described below. A characteristic of the method for controlling the bias voltage of the second embodiment is that the level detecting section 70 detects the level of the electric signal having an arbitrary frequency included in the wideband modulated signal after the wideband modulated signal is demodulated by the demodulation section 80. When a wideband modulated signal is demodulated, a component (the PM·J₀ component) that appears in the vicinity of DC as the beat component between the optical signal component (the J₊₁ component) angle-modulated with the second electric signal and the optical carrier overlaps with the second electric signal, which occurs when an intended wideband modulated signal is demodulated, whereby it may not be possible to detect the necessary signal level. In view of this, the level detecting section 70 realizes a control of the first and second bias voltages based on a signal that does not overlap with the frequency band of the second electric signal among other beat components between the J₊₂ component being the double-frequency component of the second optically modulated signal angle-modulated with the second electric signal and the optical carrier J₀ component.

The first bias voltage control and the second bias voltage control performed by the DC power supply control section 50 are as shown in the flow charts of FIGS. 3, 4 and 5, except that different signals are detected. The third bias voltage control is as shown in the flow chart of FIG. 6.

As described above, the wideband modulated signal generating device according to the second embodiment of the present invention controls the first and second bias voltages by using as a monitor signal the beat component between the J₊₂ component of the second optically modulated signal angle-modulated with the second electric signal, which occurs only when there remains an optical carrier component after demodulation, and the optical carrier component, and then monitors the distortion level to control the third bias voltage, thus realizing an efficient control flow.

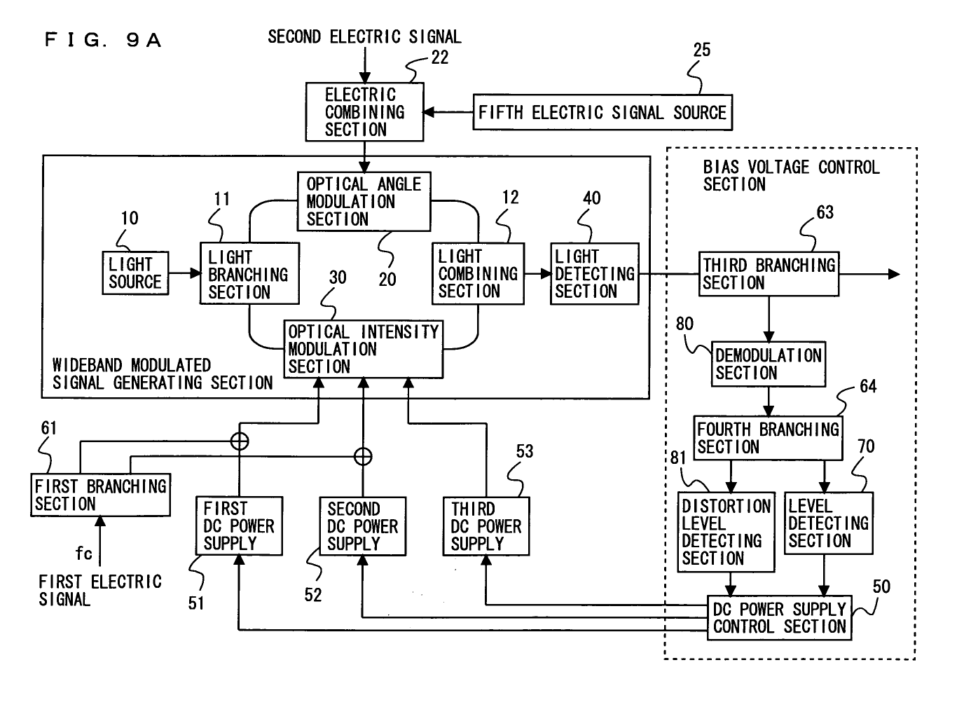

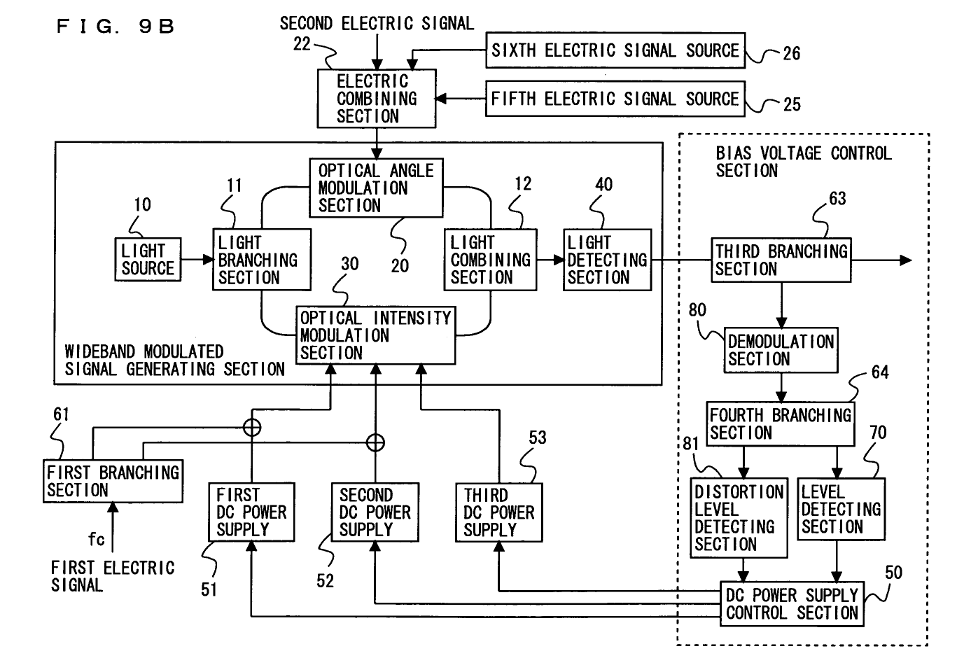

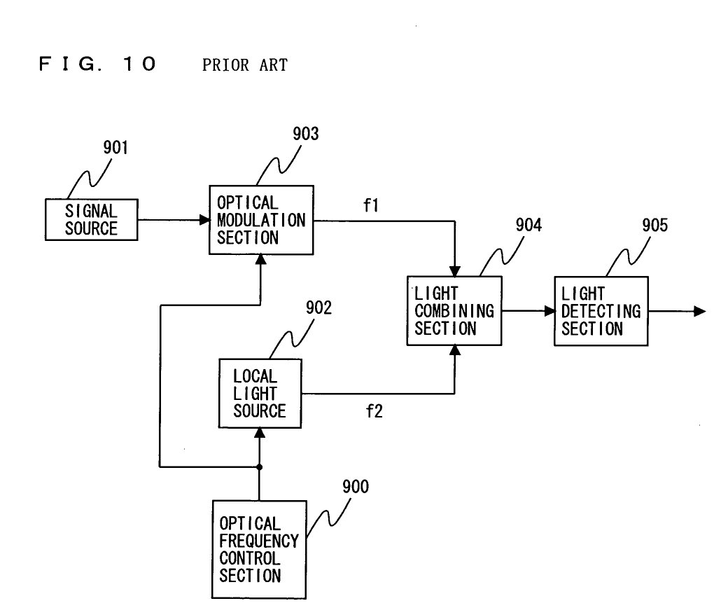

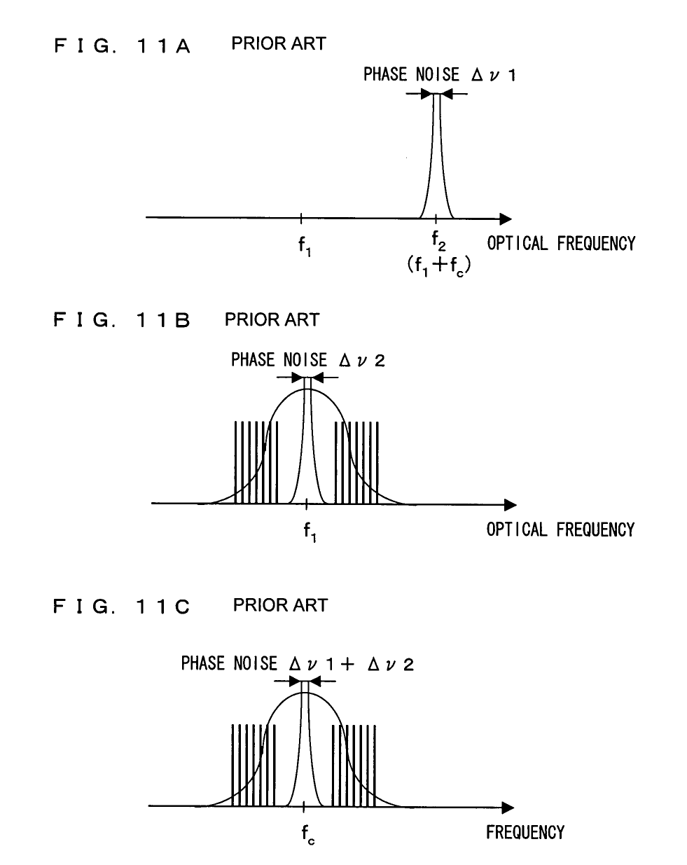

FIG. 9A shows an alternative configuration of the second embodiment. As compared with the configuration shown in FIG. 8, the wideband modulated signal generating device shown in FIG. 9A further includes the electric combining section 22 and a fifth electric signal source 25. The fifth electric signal source 25 outputs the fifth electric signal as a monitor electric signal to be inputted to the optical angle modulation section 20. The electric combining section 22 combines together the second electric signal and the fifth electric signal.

The wideband modulated signal generating device shown in FIG. 9A is the same as the configuration shown in FIG. 8 in terms of the signal flow and the process of controlling the bias voltage, and differs from the configuration shown in FIG. 8 in that a signal component that occurs at a frequency twice as high as that of the fifth electric signal is detected by the level detecting section 70 and used for controlling the first bias voltage and the second bias voltage. The second electric signal may in some cases be a signal composed only of modulated components, e.g., a video signal. It is possible to realize a control with a higher precision by using, as the original signal of the monitor signal, an unmodulated electric signal such as the fifth electric signal, rather than by using a modulated electric signal such as the second electric signal. Then, the level and the frequency of the fifth monitor electric signal can be determined arbitrarily, whereby it is possible to realize the level detecting section 70 more inexpensively with a simple configuration.

FIG. 9B shows another alternative configuration of the second embodiment. As compared with the configuration shown in FIG. 9A, the wideband modulated signal generating device shown in FIG. 9B further includes a sixth electric signal source 26. The sixth electric signal source 26 outputs the sixth electric signal as a monitor electric signal to be inputted to the optical angle modulation section 20. A characteristic of this configuration is that a distortion component (fₘ₅+fₘ₆ or fₘ₆−fₘ₅) produced by the fifth electric signal (e.g., frequency fₘ₅) and the sixth electric signal (e.g., frequency fₘ₆) is monitored as the distortion component detected by the distortion level detecting section 81 to thereby control the fifth bias voltage.

The frequency of the monitor signal is preferably such that the produced distortion component does not appear within the signal band of the second electric signal inputted to the optical angle modulation section 20. As described above, the second electric signal may in some cases be a signal composed only of modulated components, e.g., a video signal. It is possible to realize a control with a higher precision by superposing together unmodulated electric signals such as the fifth and sixth electric signals so as to detect the distortion component produced by the two electric signals, rather than by using a modulated electric signal such as the second electric signal. Since the level and the frequency of the fifth and sixth monitor electric signals can be determined arbitrarily, it is possible to realize the distortion level detecting section 81 more inexpensively with a simple configuration.

The wideband modulated signal generating device of the present invention is useful in, for example, generating a wideband modulated signal (a phase-modulated signal or a frequency-modulated signal).

While the invention has been described in detail, the foregoing description is in all aspects illustrative and not restrictive. It is understood that numerous other modifications and variations can be devised without departing from the scope of the invention.

What is claimed is:

1. A wideband modulated signal generating device, comprising:
a light source for outputting light;
a light branching section for splitting the light outputted from the light source into first light and second light;
an optical intensity modulation section for subjecting the first light to an optical intensity modulation or an optical amplitude modulation with an original signal being a first electric signal having a predetermined frequency f_{C} to output a resultant signal as a first optical signal;
an optical angle modulation section for subjecting the second light to an optical angular modulation with an original signal being a second electric signal to output a resultant signal as a second optical signal;
a light combining section for combining together the first optical signal and the second optical signal;
a light detecting section having squared detection characteristics for converting an optical signal outputted from the light combining section to an electric signal to thereby output a wideband modulated signal having a carrier frequency f_{C} with an original signal being the second electric signal;
first, second and third DC power supplies for applying first, second and third bias voltages, respectively, to the optical intensity modulation section; and
a bias voltage control section for controlling the first bias voltage and the second bias voltage applied by the first and second DC power supplies to the optical intensity modulation section based on a level of an electric signal having an arbitrary frequency included in the wideband modulated signal outputted from the light detecting section, and controlling the third bias voltage applied by the third DC power supply to the optical intensity modulation section based on a level of a distortion component at an arbitrary frequency included in a demodulated electric signal outputted from the light combining section.

2. The wideband modulated signal generating device according to claim 1, wherein the bias voltage control section controls the first DC power supply and the second DC power supply to set the first bias voltage and the second bias voltage each to a predetermined bias voltage value, and then controls the third DC power supply to set the third bias voltage to a predetermined bias voltage.

3. The wideband modulated signal generating device according to claim 1, wherein the bias voltage control section comprises:
a branching section for branching a portion of the electric signal from the light detecting section into two paths;
a signal level detecting section for extracting a component of one of the electric signals from the branching section that is within a particular band and measuring a level of the component to detect the level of an electric signal having an arbitrary frequency included in a wideband modulated signal outputted from the light detecting section;
a demodulation section for demodulating a wideband modulated signal included in the other one of the electric signals from the branching section;
a distortion level detecting section for detecting a level of a distortion component at an arbitrary frequency included in a wideband modulated signal outputted from the demodulation section; and
a bias voltage control section for controlling the first bias voltage and the second bias voltage applied by the first DC power supply and the second DC power supply, respectively, to the optical intensity modulation section so that the level of the electric signal having an arbitrary frequency detected by the signal level detecting section is less than or equal to a reference level, and controlling the third bias voltage applied by the third DC power supply to the optical intensity modulation section so that the level of the distortion component at an arbitrary frequency detected by the distortion level detecting section is less than or equal to a reference level.

4. The wideband modulated signal generating device according to claim 3, wherein the signal level detecting section detects a level of a component of the second electric signal that has a lowest frequency.

5. The wideband modulated signal generating device according to claim 3, wherein the distortion level detecting section detects a distortion component occurring within a signal band of a highest frequency among other components of the second electric signal inputted to the optical angle modulation section.

6. The wideband modulated signal generating device according to claim 3, wherein where the second electric signal includes modulated signals of different modulation schemes, the distortion level detecting section detects a distortion component occurring within a signal band of a highest frequency among other components of the second electric signal that has been modulated by a modulation scheme for which the highest performance is required.

7. The wideband modulated signal generating device according to claim 3, wherein a third electric signal is additionally superposed over the second electric signal inputted to the optical angle modulation section, and the signal level detecting section detects a level of the third electric signal.

8. The wideband modulated signal generating device according to claim 7, wherein the third electric signal has a frequency lower than that of the second electric signal.

9. The wideband modulated signal generating device according to claim 3, wherein the distortion level detecting section detects a distortion component produced by a fourth electric signal and a fifth electric signal when the fourth and fifth electric signals are superposed over the second electric signal inputted to the optical angle modulation section.

10. The wideband modulated signal generating device according to claim 9, wherein the fourth and fifth electric signals have frequencies such that a distortion component produced by the fourth electric signal and the fifth electric signal is not within a signal band of the second electric signal.

11. The wideband modulated signal generating device according to claim 1, wherein the bias voltage control section comprises:
a first branching section for branching a portion of the electric signal from the light detecting section;
a demodulation section for demodulating a wideband modulated signal included in an electric signal outputted from the first branching section;
a second branching section for branching an electric signal outputted from the demodulation section into two paths;
a signal level detecting section for detecting a level of an electric signal having an arbitrary frequency included in one of the wideband modulated signals outputted from the second branching section;
a distortion level detecting section for detecting a level of a distortion component at an arbitrary frequency included in the other one of the wideband modulated signals outputted from the second branching section; and
a bias voltage control section for controlling the first bias voltage and the second bias voltage applied by the first DC power supply and the second DC power supply, respectively, to the optical intensity modulation section so that the level of the electric signal having an arbitrary frequency detected by the signal level detecting section is less than or equal to a reference level, and controlling the third bias voltage applied by the third DC power supply to the optical intensity modulation section so that the level of the distortion component at an arbitrary frequency detected by the distortion level detecting section is less than or equal to a reference level.

12. The wideband modulated signal generating device according to claim 11, wherein the signal level detecting section detects a level of a component of the second electric signal that has a frequency twice as high as a lowest frequency thereof.

13. The wideband modulated signal generating device according to claim 11, wherein the distortion level detecting section detects a distortion component occurring within a signal band of a highest frequency among other components of the second electric signal inputted to the optical angle modulation section.

14. The wideband modulated signal generating device according to claim 11, wherein where the second electric signal includes modulated signals of different modulation schemes, the distortion level detecting section detects a distortion component occurring within a signal band of a highest frequency among other components of the second electric signal that has been modulated by a modulation scheme for which the highest performance is required.

15. The wideband modulated signal generating device according to claim 11, wherein a sixth electric signal is additionally superposed over the second electric signal inputted to the optical angle modulation section, and the signal level detecting section detects a level of an electric signal having a frequency component twice as high as that of the sixth electric signal.

16. The wideband modulated signal generating device according to claim 15, wherein the sixth electric signal has a frequency lower than that of the second electric signal.

17. The wideband modulated signal generating device according to claim 11, wherein the distortion level detecting section detects a distortion component produced by a seventh electric signal and an eighth electric signal when the seventh and eighth electric signals are superposed over the second electric signal inputted to the optical angle modulation section.

18. The wideband modulated signal generating device according to claim 17, wherein the seventh and eighth electric signals have frequencies such that a distortion component produced by the seventh electric signal and the eighth electric signal is not within a signal band of the second electric signal.
